(19) United States
(12) Patent Application Publication
(10) Pub. No.: US 2016/0379216 A1
(43) Pub. Date: Dec. 29, 2016

(54) AUTOMATIC CHARGEBACK MANAGEMENT

(71) Applicant: Vantiv, LLC, Cincinnati, OH (US)

(72) Inventors: Fengzhong Wang, Boston, MA (US); Jeffrey C. Courcelle, Reading, MA (US); William H. Cohn, Lexington, MA (US)

(21) Appl. No.: 14/751,343

(22) Filed: Jun. 26, 2015

(51) Int. Cl. G06Q 20/40

(52) U.S. Cl. CPC G06Q 20/407; G06Q 20/4016

(57) ABSTRACT

Technologies for automatically managing chargebacks include a chargeback processing server for receiving a chargeback corresponding to a disputed payment vehicle transaction and analyzing chargeback data as a function of historical chargeback win data and transaction-specific economic feasibility data. The chargeback processing server automatically determines, based on the analysis of the chargeback data, whether further review of the chargeback is necessary, whether to automatically represent the disputed payment vehicle transaction, or whether to automatically accept financial liability for the disputed payment vehicle transaction. Additionally, the chargeback processing server automatically collects representment evidence in response to determining to automatically represent the disputed payment vehicle transaction. Other embodiments are described and claimed.

### TECHNICAL FIELD

Embodiments of the technologies described herein relate, in general, to the field of payment transactions. More particularly, the technologies described herein relate to the field of automatically managing chargebacks for disputed payment transactions.

### BACKGROUND

A chargeback is the return of funds to an account holder forcibly initiated by an issuing bank of the instrument used by the account holder to settle a debt. Specifically, a chargeback is the reversal of a prior outbound transfer of funds from an account holder's bank account, line of credit, or credit card. An account holder may initiate a chargeback by contacting their issuing bank, and filing a substantiated complaint regarding one or more debit items on their statement. The threat of forced reversal of funds provides merchants with an incentive to provide quality products, helpful customer service, and timely refunds, as appropriate. Chargebacks also provide a means for reversal of unauthorized transfers due to identity theft. Chargebacks can also occur as a result of friendly fraud, where the transaction was authorized by the consumer but the consumer later attempts to fraudulently reverse the charges. Chargebacks can be financially detrimental to the merchant and can affect the ability of the merchant to accept certain payment vehicles in the future.

### SUMMARY

In an embodiment, the present disclosure is directed, in part, to a method for automatic chargeback management, the method includes receiving, by a chargeback processing server, a chargeback message corresponding to a disputed payment vehicle transaction, the chargeback message comprises chargeback data indicative of a transaction amount, an account identifier, and a chargeback reason code. The method further includes analyzing, by the chargeback processing server, the chargeback data as a function of historical chargeback win data and transaction-specific economic feasibility data and determining, by the chargeback processing server, whether further review of the chargeback data is required based on the analysis of the chargeback data. The method also includes determining, by the chargeback processing server and in response to determining that further review of the chargeback data is not required, whether to automatically represent the disputed payment vehicle transaction or automatically accept financial liability for the disputed payment vehicle transaction based on the analysis of the chargeback data. In addition, the method includes transmitting, by the chargeback processing server, a representment message in response to determining to automatically represent the disputed payment vehicle transaction and transmitting, by the chargeback processing server, a liability acceptance message in response to determining to automatically accept financial liability for the disputed payment vehicle transaction.

In another embodiment, the present disclosure is directed, in part, to one or more machine-readable storage media including a plurality of instructions stored thereon that in response to being executed by a chargeback processing server, cause the chargeback processing controller to receive a chargeback message that corresponds to a disputed payment vehicle transaction, the chargeback message comprises chargeback data indicative of a transaction amount, an account identifier, and a chargeback reason code. The plurality of instructions further cause the chargeback processing server to analyze the chargeback data as a function of historical chargeback win data and transaction-specific economic feasibility data and determine whether further review of the chargeback data is required based on the analysis of the chargeback data. The plurality of instructions also cause the chargeback processing server to determine, in response to a determination that further review of the chargeback data is not required, whether to automatically represent the disputed payment vehicle transaction or automatically accept financial liability for the disputed payment vehicle transaction based on the analysis of the chargeback data. In addition, the plurality of instructions cause the chargeback processing server to transmit a representment message in response to a determination to automatically represent the disputed payment vehicle transaction and transmit a liability acceptance message in response to a determination to automatically accept financial liability for the disputed payment vehicle transaction.

In another embodiment, the present disclosure is directed, in part, to a system for automatic chargeback management, the system includes a chargeback processing server having a processor executing instructions stored in memory, wherein the instructions cause the processor to receive a chargeback message that corresponds to a disputed payment vehicle transaction, the chargeback message comprises chargeback data indicative of a transaction amount, an account identifier, and a chargeback reason code. The instructions further cause the processor to analyze the chargeback data as a function of historical chargeback win data and transaction-specific economic feasibility data and determine whether further review of the chargeback data is required based on the analysis of the chargeback data. The instructions also cause the processor to determine, in response to a determination that further review of the chargeback data is not required, whether to automatically represent the disputed payment vehicle transaction or automatically accept financial liability for the disputed payment vehicle transaction based on the analysis of the chargeback data. In addition, the instructions cause the processor to transmit a representment message in response to a determination to automatically represent the disputed payment vehicle transaction and transmit a liability acceptance message in response to a determination to automatically accept financial liability for the disputed payment vehicle transaction.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of at least one embodiment of a system for automatically managing chargeback requests for disputed payment transactions;

FIG. 2 is a simplified block diagram of at least one embodiment of the chargeback processing server of the system of FIG. 1;

FIG. 3 is a simplified flow diagram of at least one embodiment of a method that may be executed by the chargeback processing server of FIG. 1 for automatically managing chargeback requests for disputed payment transactions; and

FIG. 4 is a simplified flow diagram of at least one embodiment of a method that may be executed by the chargeback processing server of FIG. 1 for collecting representment evidence.

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

For simplicity, the description that follows will be provided by reference to a “payment vehicle” or a “payment card,” which generally refers to any type of financial alternative to currency. As is to be clear to those skilled in the art, no aspect of the present disclosure is specifically limited to a specific type of payment vehicle or payment card. Therefore, it is intended that the following description encompasses the use of the present disclosure with many other forms of financial alternatives to currency, including credit cards, debit cards, smart cards, single-use cards, pre-paid cards, electronic currency (such as might be provided through a cellular telephone or personal digital assistant), and the like. Payment vehicles or payment card can be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument.

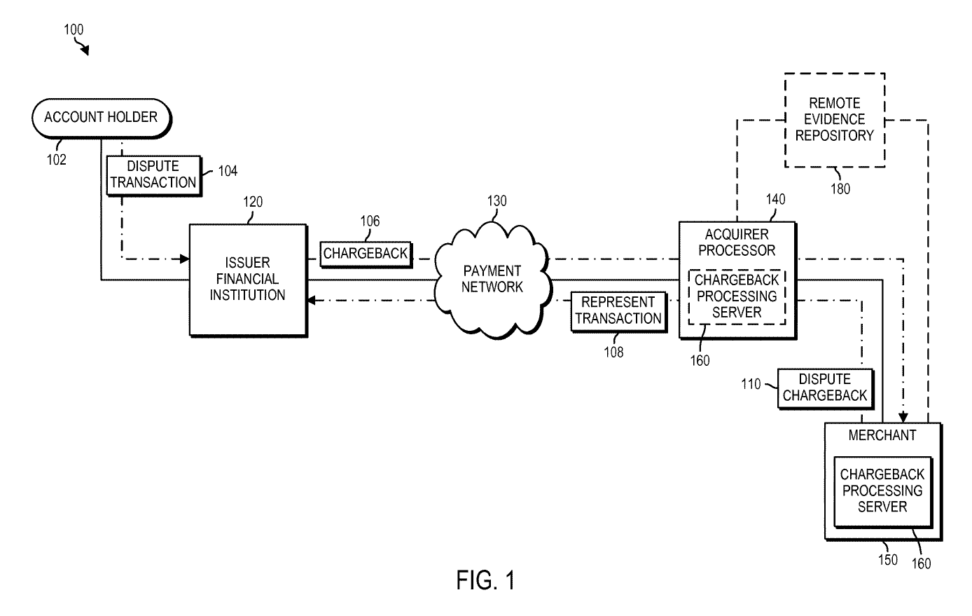

Referring now to FIG. 1, in one embodiment, a system 100 for automatically managing chargeback requests for disputed payment transactions includes an issuer financial institution 120, a payment network 130, an acquirer processor 140, a merchant 150, and a chargeback processing server 160. In some embodiments, the system 100 also includes a remote evidence repository 180. Additionally, it should be appreciated that although the merchant 150 is shown as including the chargeback processing server 160 in the illustrative embodiment, in other embodiments the acquirer processor 140 may include the chargeback processing server 160.

In the illustrative embodiment, an account holder 102 can dispute a payment vehicle transaction 104 corresponding to a product or service provided by the merchant 150. To do so, the account holder 102 files a complaint with the issuer financial institution 120 that issued the particular payment vehicle used by the account holder 102 during the disputed payment vehicle transaction. In response to receiving the complaint, the issuer financial institution 120 initiates a chargeback on behalf of the account holder 102. To do so, the issuer financial institution 120 can generate a chargeback message 106, which can be transmitted to the acquirer processor 140 via the payment network 130. The chargeback message 106 can then be forwarded to the chargeback processing server 160 of the merchant 150 for further processing.

In response to receiving a chargeback, the merchant 150 is provided an opportunity to dispute the chargeback 110, if desired, to the issuer financial institution 120. In some embodiments, the chargeback processing server 160 automatically determines whether to dispute the chargeback. To do so, the chargeback processing server 160 of the merchant 150 can analyze chargeback data (e.g., a transaction amount, a chargeback reason code, a bank identification number, an account identifier, account holder information, etc.) included with the chargeback message 106. In some embodiments, the chargeback processing server 160 analyzes the chargeback data based at least in part on, or otherwise as a function of, historical chargeback win data and economic feasibility data. Based on that analysis, the chargeback processing server 160 can determine whether to automatically initiate a chargeback representment, automatically accept financial liability for the chargeback, or automatically queue or flag the chargeback for further review by a chargeback analyst. In embodiments in which the chargeback processing server 160 determines to automatically initiate a chargeback representment, the chargeback processing server 160 and/or the acquirer processor 140 can generate a representment message 108, which can be transmitted to the issuer financial institution 120 via the payment network 130. In embodiments in which the acquirer processor 140 generates the representment message, the chargeback processing server 160 of the merchant 150 can notify or otherwise inform the acquirer processor 140 of the decision to dispute the chargeback. Additionally, in some embodiments, the chargeback processing server 160 can collect (e.g., retrieve, obtain, etc.) representment evidence to support, or otherwise substantiate, the chargeback dispute. In such embodiments, the collected representment evidence may be used to augment or enrich the representment message 108 generated by the acquirer processor 140 and/or the chargeback processing server 160.

The issuer financial institution 120 can be any of a variety of financial institutions that is capable of issuing a payment vehicle to the account holder 102, managing accounts associated with the account holder 102, and facilitating payment vehicle transaction disputes (e.g., chargebacks) between the account holder 102 and the merchant 150 (or multiple merchants). The payment network 130 can be, for example, a network of a credit card association affiliated with a payment vehicle issued to the account holder 102. Non-limiting examples of credit card associations include VISA, MASTERCARD, DISCOVER, and AMERICAN EXPRESS. The acquirer processor 140 can process payment vehicle transactions between an account of the account holder 102 and an account of the merchant 150. In some embodiments, the acquirer processor 140 can include the chargeback processing server 160.

The merchant 150 can be embodied as any type of entity that provides goods or services to the account holder 102 in exchange for payment. The merchant 150 can include one or more devices that facilitate receipt of a payment vehicle for payment of a purchase. In some embodiments, such as the one illustratively shown in FIG. 1, the merchant 150 includes the chargeback processing server 160.

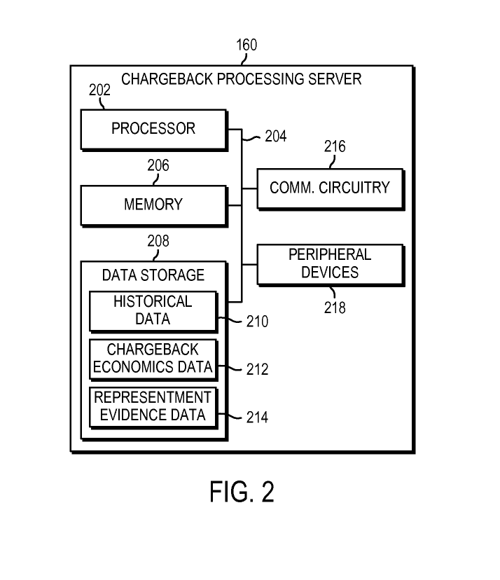

Referring now to FIG. 2, the chargeback processing server 160 of the system 100 can be embodied as any type of computing device or server or capable of processing, communicating, storing, maintaining, and transferring data. For example, the chargeback processing server 160 can be embodied as a server, a microcomputer, a minicomputer, a mainframe, a desktop computer, a laptop computer, a mobile computing device, a handheld computer, a smart phone, a tablet computer, a personal digital assistant, a telephony device, a custom chip, an embedded processing device, or other computing device and/or suitable programmable device. In some embodiments, the chargeback processing server 160 can be embodied as a computing device integrated with other systems or subsystems. In the illustrative embodiment of FIG. 2, the chargeback processing server 160 includes a processor 202, a system bus 204, a memory 206, a data storage 208, communication circuitry 216, and one or more peripheral devices 218. Of course, the chargeback processing server 160 can include other or additional components, such as those commonly found in a server and/or computer (e.g., various input/output devices), in other embodiments. Additionally, in some embodiments, one or more of the illustrative components can be incorporated in, or otherwise from a portion of, another component. For example, the memory 206, or portions thereof, can be incorporated in the processor 202 in some embodiments. Furthermore, it should be appreciated that the chargeback processing server 160 can include other components, sub-components, and devices commonly found in a computer and/or computing device, which are not illustrated in FIG. 2 for clarity of the description.

The processor 202 can be embodied as any type of processor capable of performing the functions described herein. For example, the processor 202 can be embodied as a single or multi-core processor, a digital signal processor, microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

In various configurations, the chargeback processing server 160 includes a system bus 204 for interconnecting the various components of the chargeback processing server 160. The system bus 204 can be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations with the processor 202, the memory 206, and other components of the chargeback processing server 160. In some embodiments, the chargeback processing server 160 can be integrated into one or more chips such as a programmable logic device or an application specific integrated circuit (ASIC). In such embodiments, the system bus 204 can form a portion of a system-on-a-chip (SoC) and be incorporated, along with the processor 202, the memory 206, and other components of the chargeback processing server 160, on a single integrated circuit chip.

The memory 206 can be embodied as any type of volatile or non-volatile memory or data storage capable of performing the functions described herein. For example, the memory 206 can be embodied as read only memory (ROM), random access memory (RAM), cache memory associated with the processor 202, or other memories such as dynamic RAM (DRAM), static ram (SRAM), programmable ROM (PROM), electrically erasable PROM (EEPROM), flash memory, a removable memory card or disk, a solid state drive, and so forth. In operation, the memory 206 can store various data and software used during operation of the chargeback processing server 160 such as operating systems, applications, programs, libraries, and drivers.

The data storage 208 can be embodied as any type of device or devices configured for short-term or long-term storage of data such as, for example, memory devices and circuits, memory cards, hard disk drives, solid-state drives, or other data storage devices. For example, in some embodiments, the data storage 208 includes storage media such as a storage device that can be configured to have multiple modules, such as magnetic disk drives, floppy drives, tape drives, hard drives, optical drives and media, magneto-optical drives and media, compact disc drives, Compact Disc Read Only Memory (CD-ROM), Compact Disc Recordable (CD-R), Compact Disc Rewriteable (CD-RW), a suitable type of Digital Versatile Disc (DVD) or Blu-Ray disc, and so forth. Storage media such as flash drives, solid state hard drives, redundant array of individual disks (RAID), virtual drives, networked drives and other memory means including storage media on the processor 202, or the memory 206 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

In some embodiments, the data storage device 208 can be configured to store historical data 210. The historical data 210 can include global historical win rates (or percentages) indicative of how often a group of merchants (e.g., a global population of merchants) successfully disputed particular types of chargebacks. For example, based on the particular chargeback reason code, a corresponding global historical win rate can be stored that indicates how often merchants successfully disputed (e.g., won, resolved, etc.) a particular type of chargeback. In some embodiments, the historical data 210 can also include merchant-specific win rates (or percentages) indicative of how often a specific merchant successfully disputed particular types of chargebacks. For example, based on the particular chargeback reason code, a corresponding merchant-specific historical win rate can be stored that indicates how often a merchant successfully disputed (e.g., won, resolved, etc.) a particular type of chargeback. Additionally or alternatively, the historical data 210 can include global historical win rates (or percentages) and/or merchant-specific win rates (or percentages) indicative of how often, based on a bank identification number, a merchant or a group of merchants successfully disputed a particular type of chargeback.

Additionally, in some embodiments, the data storage 208 is configured to store chargeback economics data 212. For example, the data storage 208 is configured to store chargeback cost data. The chargeback cost data can be indicative of the service fee(s), processing fee(s), and/or any other type of cost or fee associated with initiating or disputing a chargeback in connection with a payment vehicle transaction. Such fees and costs can be charged by the issuer financial institution 120, the payment network 130, the acquirer processor 140, and/or any other entity in a payment ecosystem. The data storage 208 can also be configured to store analyst time cost data indicative of the estimated cost to have an analyst manually review a chargeback. In some embodiments, such estimated costs can be calculated based on the amount of time it would take an analyst to dispose (e.g., dispute or accept financial liability) of a chargeback and a reference hourly rate of a typical analyst. It should be appreciated that the chargeback cost data and the analyst time cost data can be based on a particular type of chargeback and/or a particular bank identification number associated with a disputed payment vehicle transaction. As such, the data storage 208 can include a chargeback cost and an analyst time cost for each of a plurality of different chargeback reason codes. Additionally or alternatively, the data storage 208 can include a chargeback cost and an analyst time cost for one or more bank identification numbers or groups of bank identification numbers.

The data storage 208 can also be configured to store representment evidence 214. In embodiments in which the merchant 150 is a service provider, a digital content provider, a software as a service provider, or the like, the representment evidence 214 can include an electronic copy of the merchant's 150 transaction terms and conditions. Additionally, in embodiments in which the merchant 150 is a physical goods shipper, the representment evidence 214 can include shipping data such as, for example, tracking numbers, tracking information, delivery confirmation information (e.g., proof of delivery evidence), and the like. It should be appreciated, however, that the representment evidence 214 can include any other type of “compelling evidence” or documentary evidence associated with the merchant 150 and/or the disputed payment vehicle transaction. As discussed, the representment evidence 214 can be used to support, or otherwise substantiate, chargeback disputes by the merchant 150.

The communication circuitry 216 of the chargeback processing server 160 may be embodied as any type of communication circuit, device, interface, or collection thereof, capable of enabling communications between the chargeback processing server 160 and the issuer financial institution 120 (or computing devices thereof), the payment network 130 (or computing devices thereof), the acquirer processor 140 (e.g., or computing devices thereof), the remote evidence repository 180, and/or any other computing device communicatively coupled thereto. For example, the communication circuitry 216 may be embodied as one or more network interface controllers (NICs), in some embodiments. The communication circuitry 216 may be configured to use any one or more communication technologies (e.g., wireless or wired communications) and associated protocols (e.g., Ethernet, Wi-Fi®, WiMAX, etc.) to effect such communication.

In some embodiments, the chargeback processing server 160 and the issuer financial institution 120 (or computing devices thereof), the payment network 130 (or computing devices thereof), the acquirer processor 140 (e.g., or computing devices thereof), the remote evidence repository 180, and/or any other computing devices of the system 100, can communicate with each other over one or more networks. The network(s) can be embodied as any number of various wired and/or wireless communication networks. For example, the network(s) can be embodied as or otherwise include a local area network (LAN), a wide area network (WAN), a cellular network, or a publicly-accessible, global network such as the Internet. Additionally, the network(s) can include any number of additional devices to facilitate communication between the computing devices of the system 100.

Additionally, in some embodiments, the chargeback processing server 160 can further include one or more peripheral devices 218. Such peripheral devices 218 can include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

Referring back to FIG. 1, the remote evidence repository 180 can be embodied as any type of computing device capable of performing the functions described herein. As such, the remote evidence repository 180 can include devices and structures commonly found in computing devices such as processors, memory devices, communication circuitry, and data storages, which are not shown in FIG. 1 for clarity of the description. The remote evidence repository 180 can be configured to store shipping data such as, for example, tracking numbers, tracking information, delivery confirmation information (e.g., proof of delivery evidence), or the like. In some embodiments, the remote evidence repository 180 is configured to communicate with one or more shipping providers to obtain such information. It should be appreciated that the remote evidence repository 180 can also be configured to obtain and/or store other forms of documentary evidence, in some embodiments.

In some embodiments, the issuer financial institution 120 (or computing devices thereof), the payment network 130 (or computing devices thereof), the acquirer processor 140 (or computing devices thereof), the merchant 150 (or computing devices thereof), the chargeback processing server 160, and the remote evidence repository 180 (or computing devices thereof) can each establish an environment during operation. Each environment can include various modules, components, sub-components, and devices commonly found in computing devices, which are not illustrated in the figures for clarity of the description. The various modules, components, sub-components, and devices of each environment can be embodied as hardware, firmware, software, or a combination thereof. For example, one or more of the modules, components, sub-components, and devices of each environment can be embodied as a processor and/or a controller configured to provide the functionality described herein.

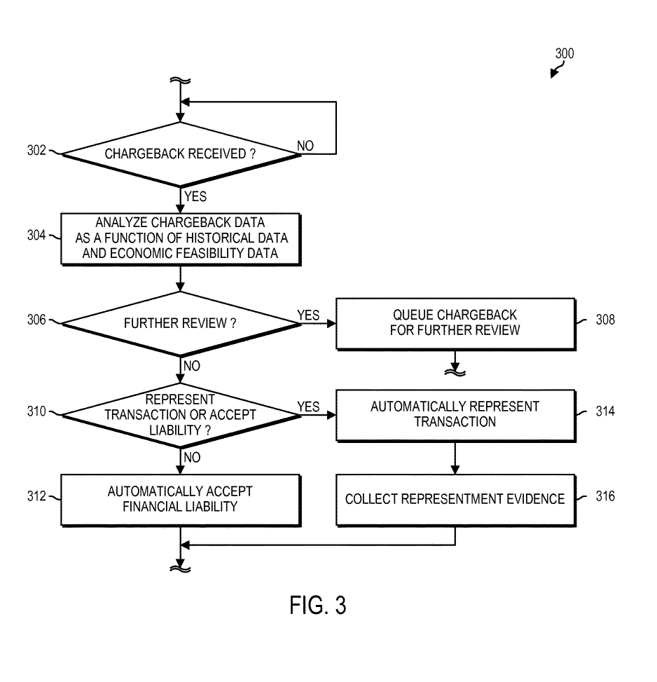

Referring now to FIG. 3, a method 300 that may be executed by the chargeback processing server 160 for automatically managing chargebacks begins with decision block 302 in which the chargeback processing server 160 determines whether a chargeback is received. For example, in some embodiments, the chargeback processing server 160 determines whether a chargeback message 106 is received from the issuer financial institution 120 via the payment network 130. The chargeback message 106 can include, for example, a transaction amount, a chargeback reason code, a bank identification number, an account identifier, account holder information, and any other type of information associated with the payment vehicle transaction being disputed. In embodiments in which the merchant 150 includes the chargeback processing server 160, the chargeback message 106 can be received from the acquirer processor 140 (or a computing device thereof), which can receive the chargeback message from the issuer financial institution 120 via the payment network 130. If, in decision block 302, the chargeback processing server 160 determines that a chargeback message 106 is received, the method 300 advances to block 304. If, however, the chargeback processing server 160 determines instead that a chargeback message 106 is not received, the method 300 loops back to decision block 302 and the chargeback processing server 160 continues monitoring for receipt of a chargeback message 106.

In block 304, the chargeback processing server 160 analyzes the chargeback data as a function of historical chargeback win data and transaction-specific economic feasibility data. In some embodiments, the historical win rate data can include global historical win rates (or percentages) indicative of how often, based on the particular chargeback reason code, a group of merchants (e.g., a global population of merchants) successfully disputed particular types of chargebacks. Additionally or alternatively, the historical win rate data can include merchant-specific win rates (or percentages) indicative of how often, based on the particular chargeback reason code, a specific merchant successfully disputed particular types of chargebacks. The historical win rate data can also include global historical win rates (or percentages) and/or merchant-specific win rates (or percentages) indicative of how often, based on a bank identification number, a merchant or a group of merchants successfully disputed a particular type of chargeback. The transaction-specific economic feasibility data can be embodied as the chargeback economics data 212 stored in the data storage 208, in some embodiments. For example, the transaction-specific economic feasibility data can include chargeback cost data, which can be embodied as the service fee(s), processing fee(s), and/or any other type of cost or fee associated with initiating the chargeback or disputing the chargeback for the payment vehicle transaction at issue.

In some embodiments, to analyze the chargeback data as a function of the historical chargeback win data and transaction-specific economic feasibility data, the chargeback processing server 160 determines whether a biased transaction amount is greater than a first reference threshold and whether the biased transaction amount is less than a second reference threshold amount. The biased transaction amount is embodied as the product of the historical win rate for a particular chargeback reason code and an adjusted gross transaction amount. Additionally or alternatively, in some embodiments, the biased transaction amount is embodied as the product of the historical win rate for a particular chargeback reason code, a particular bank identification number (or a group of bank identification numbers), and an adjusted gross transaction amount. The adjusted gross transaction amount is embodied as the difference between the transaction amount of the disputed payment vehicle transaction and the chargeback cost(s) associated with the chargeback reason code and/or bank identification number corresponding to the disputed payment vehicle transaction. In some embodiments, the first reference threshold amount is greater than the second reference threshold amount.

In decision block 306, the chargeback processing server 160 determines whether further review of the chargeback and/or the chargeback data is required based on the analysis of the chargeback data. To do so, in some embodiments, the chargeback processing server 160 determines whether the biased transaction amount is between the first and second reference threshold amounts. In such embodiments, the chargeback processing server 160 can determine that further review of the chargeback and/or the chargeback data is required. It should be appreciated, however, that the chargeback processing server 160 can determine that further review of the chargeback and/or the chargeback data is required in response to determining that the biased transaction amount is greater than, less than, or equal to the first reference threshold amount and/or the second reference threshold amount. If, in decision block 306, the chargeback processing server 160 determines that further review of the chargeback and/or the chargeback data is not required, the method 300 advances to decision block 310. If, however, the chargeback processing server 160 determines instead that further review of the chargeback and/or the chargeback data is required, the method 300 advances to block 308.

In block 308, the chargeback processing server 160 queues the chargeback for further review. For example, in some embodiments, the chargeback processing server 160 can add the chargeback to an electronic queue for further review by an analyst. In such embodiments, the analyst can access the electronic queue and determine whether to represent the chargeback and/or accept financial liability for the chargeback.

In decision block 310, the chargeback processing server 160 determines whether to automatically represent the chargeback (e.g., dispute the disputed payment vehicle transaction) or automatically accept financial liability for the chargeback (e.g., assume liability for the disputed payment vehicle transaction) based on the analysis of the chargeback data. For example, in some embodiments, the chargeback processing server 160 can determine to automatically represent the chargeback in response to determining that the biased transaction amount is greater than the first reference threshold amount (or both the first and second reference threshold amounts). Additionally, in some embodiments, the chargeback processing server 160 can determine to automatically accept financial liability for the chargeback in response to determining that the biased transaction amount is less than the second reference threshold amount (or both the first and second reference threshold amounts). It should be appreciated that, in some embodiments, the chargeback processing server 160 can determine to automatically represent the chargeback or determine to automatically accept financial liability for the chargeback in response to, or subsequent to, determining that further review of the chargeback and/or the chargeback data is not required. If, in decision block 310, the chargeback processing server 160 determines to automatically represent the chargeback, the method 300 advances to block 314. If, however, the chargeback processing server 160 determines instead to automatically accept financial liability for the chargeback, the method 300 advances to block 312.

In block 312, the chargeback processing server 160 automatically accepts financial liability for the chargeback (e.g., assumes liability for the disputed payment vehicle transaction). To do so, in some embodiments, the chargeback processing server 160 generates a liability acceptance message. In such embodiments, the liability acceptance message can be transmitted to the acquirer processor 140, the payment network 130, the issuer financial institution 120, or computing devices thereof. It should be appreciated that the chargeback processing server 160 can automatically accept financial liability for the chargeback and inform the acquirer processor 140, the payment network 130, and/or the issuer financial institution 120 via any other suitable notification message, process, or technology.

In block 314, the chargeback processing server 160 automatically represents the chargeback (e.g., disputes the disputed payment vehicle transaction). To do so, in some embodiments, the chargeback processing server 160 generates a representment message 108. The representment message 108 can be transmitted to the acquirer processor 140, the payment network 130, the issuer financial institution 120, or computing devices thereof. In some embodiments, the representment message 108 includes representment evidence that supports, or otherwise substantiates, the merchant's 150 dispute of the chargeback. For example, in some embodiments, the representment evidence can include an electronic copy of the merchant's 150 transaction terms and conditions, shipping data, or any other type of “compelling evidence” or documentary evidence associated with the merchant 150 and/or the disputed payment vehicle transaction.

In block 316, the chargeback processing server 160 collects the representment evidence to include with the representment message transmitted to the acquirer processor 140, the payment network 130, the issuer financial institution 120, or computing devices thereof. In some embodiments, the representment evidence is collected (e.g., obtained, retrieved, etc.) from a local storage (e.g., the data storage 208, etc.) of the chargeback processing server 160. Additionally or alternatively, the representment evidence is collected (e.g., obtained, retrieved, etc.) from the remote evidence repository 180. In either case, the collected representment evidence can be used by the chargeback processing server 160 to augment, or otherwise enrich, the representment message 108.

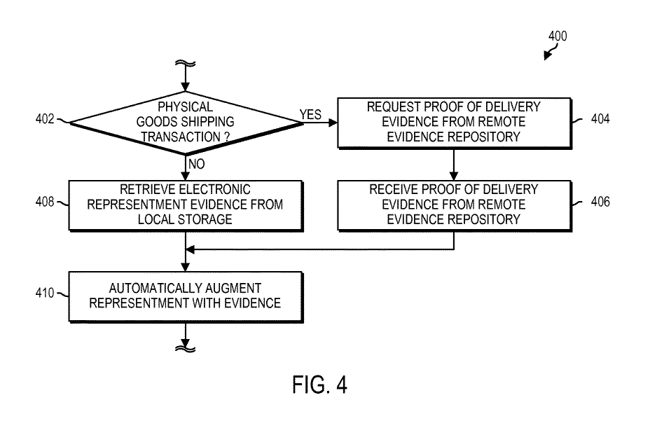

Referring now to FIG. 4, a method 400 that may be executed by the chargeback processing server 160 for collecting representment evidence begins with decision block 402 in which the chargeback processing server 160 determines whether a disputed payment vehicle transaction is a physical goods shipping transaction. For example, the chargeback processing server 160 can determine whether the disputed payment vehicle transaction corresponds to a transaction in which physical goods or products were shipped or delivered to a consumer (e.g., the account holder 102). If, in decision block 402, the chargeback processing server 160 determines that the disputed payment vehicle transaction corresponds to a transaction other than one in which goods or products were shipped or delivered to a consumer (e.g., a service or digital transaction), the method 400 advances to block 408. If, however, the chargeback processing server 160 determines instead that the disputed payment vehicle transaction corresponds to a transaction in which goods or products were shipped or delivered to a consumer, the method 400 advances to block 404.

In block 404, the chargeback processing server 160 requests proof of delivery and/or proof of shipment evidence from the remote evidence repository 180. It should be appreciated that the chargeback processing server 160 can request other types of shipping data or evidence (e.g., tracking numbers, tracking information, etc.) from the remote evidence repository 180, in some embodiments. Thereafter, in block 406, the chargeback processing server 160 can receive the requested proof of delivery and/or proof of shipment evidence from the remote evidence repository 180.

In block 408, the chargeback processing server 160 collects electronic representment evidence from a local storage of the chargeback processing server 160. For example, in some embodiments, the chargeback processing server 160 retrieves (e.g., collects, obtains, etc.) an electronic copy of the merchant's 150 transaction terms and conditions from the data storage 208. It should be appreciated that the chargeback processing server 160 can retrieve or collect any other type of representment evidence from local storage.

In block 410, the chargeback processing server 160 automatically augments, or otherwise enriches, the representment message 108 to include the collected representment evidence (e.g., the electronic terms and conditions and/or the proof of delivery evidence). Such representment evidence can be used to support, or otherwise substantiate, chargeback disputes by the merchant 150.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

1. A method for automatic chargeback management, the method comprising:
receiving, by a chargeback processing server, a chargeback message corresponding to a disputed payment vehicle transaction, the chargeback message comprises chargeback data indicative of a transaction amount, an account identifier, and a chargeback reason code;
analyzing, by the chargeback processing server, the chargeback data as a function of historical chargeback win data and transaction-specific economic feasibility data;
determining, by the chargeback processing server, whether further review of the chargeback data is required based on the analysis of the chargeback data;
determining, by the chargeback processing server and in response to determining that further review of the chargeback data is not required, whether to automatically represent the disputed payment vehicle transaction or automatically accept financial liability for the disputed payment vehicle transaction based on the analysis of the chargeback data;
transmitting, by the chargeback processing server, a representment message in response to determining to automatically represent the disputed payment vehicle transaction; and
transmitting, by the chargeback processing server, a liability acceptance message in response to determining to automatically accept financial liability for the disputed payment vehicle transaction.

2. The method of claim 1, further comprising:
collecting, by the chargeback processing server, representment evidence in response to determining to automatically represent the disputed payment vehicle transaction; and
augmenting, by the chargeback processing server, the representment message with the collected representment evidence.

3. The method of claim 2, further comprising:
determining, by the chargeback processing server, whether the disputed payment vehicle transaction is a physical goods shipping transaction;
requesting, by the chargeback processing server and from a remote evidence repository, proof of delivery evidence in response to determining that the disputed payment vehicle transaction is a physical goods shipping transaction; and
receiving, by the chargeback processing server and from the remote evidence repository, the proof of delivery evidence, wherein the collected representment evidence comprises the received proof of delivery evidence.

4. The method of claim 3, wherein collecting the representment evidence comprises retrieving the representment evidence from a local storage in response to determining that the disputed payment vehicle transaction is a transaction other than a physical goods shipping transaction.

5. The method of claim 4, wherein the representment evidence retrieved from the local storage comprises an electronic set of terms and conditions of a merchant associated with the disputed payment vehicle transaction.

6. The method of claim 1, further comprising queuing, by the chargeback processing server and in response to determining that further review of the chargeback data is required, the chargeback message corresponding to the disputed payment vehicle transaction in a queue for further review.

7. The method of claim 1, wherein the historical chargeback win data comprises a historical win rate and the transaction-specific economic feasibility data comprises a chargeback cost;
wherein analyzing the chargeback data as a function of the historical chargeback win data and transaction-specific economic feasibility data comprises (i) determining whether a biased transaction amount is greater than a first reference threshold amount and (ii) determining whether the biased transaction amount is less than a second reference threshold amount, wherein the biased transaction amount comprises a product of the historical win rate and an adjusted gross transaction amount, the adjusted gross transaction amount comprises a difference between the transaction amount and the chargeback cost, and the first reference threshold amount is greater than the second reference threshold amount;
wherein determining whether further review of the chargeback data is required comprises determining that further review of the chargeback data is required in response to determining that the biased transaction amount is between the first and second reference threshold amounts; and
wherein determining whether to automatically represent the disputed payment vehicle transaction or automatically accept financial liability for the disputed payment vehicle transaction comprises (i) determining to automatically represent the disputed payment vehicle transaction in response to determining that the biased transaction amount is greater than the first reference threshold amount and (ii) determining to automatically accept financial liability for the disputed payment vehicle transaction in response to determining that the biased transaction amount is less than the second reference threshold amount.

8. The method of claim 7, wherein the chargeback cost comprises a chargeback fee associated with the disputed payment vehicle transaction and an estimated analyst time cost associated with the disputed payment vehicle transaction based on the chargeback reason code.

9. The method of claim 7, wherein the historical win rate comprises one or more of a global historical win rate and a merchant-specific historical win rate based on the chargeback reason code.

10. The method of claim 7, wherein the account identifier comprises a bank identification number; and
wherein the historical win rate comprises one or more of a global historical win rate and a merchant-specific historical win rate based on the chargeback reason code and the bank identification number.

11. One or more machine-readable storage media comprising a plurality of instructions stored thereon that in response to being executed by a chargeback processing server, cause the chargeback processing server to:
receive a chargeback message that corresponds to a disputed payment vehicle transaction, the chargeback message comprises chargeback data indicative of a transaction amount, an account identifier, and a chargeback reason code;
analyze the chargeback data as a function of historical chargeback win data and transaction-specific economic feasibility data;
determine whether further review of the chargeback data is required based on the analysis of the chargeback data;
determine, in response to a determination that further review of the chargeback data is not required, whether to automatically represent the disputed payment vehicle transaction or automatically accept financial liability for the disputed payment vehicle transaction based on the analysis of the chargeback data;
transmit a representment message in response to a determination to automatically represent the disputed payment vehicle transaction; and
transmit a liability acceptance message in response to a determination to automatically accept financial liability for the disputed payment vehicle transaction.

12. The one or more machine-readable storage media of claim 11, wherein the plurality of instructions further cause the chargeback processing server to:
collect representment evidence in response to the determination to automatically represent the disputed payment vehicle transaction; and
augment the representment message with the collected representment evidence.

13. The one or more machine-readable storage media of claim 12, wherein the plurality of instructions further cause the chargeback processing server to:
determine whether the disputed payment vehicle transaction is a physical goods shipping transaction;
request, from a remote evidence repository, proof of delivery evidence in response to a determination that the disputed payment vehicle transaction is a physical goods shipping transaction; and
receive, from the remote evidence repository, the proof of delivery evidence, wherein the collected representment evidence comprises the received proof of delivery evidence.

14. The one or more machine-readable storage media of claim 13, wherein to collect the representment evidence comprises to retrieve the representment evidence from a local storage in response to a determination that the disputed payment vehicle transaction is a transaction other than a physical goods shipping transaction.

15. The one or more machine-readable storage media of claim 14, wherein the representment evidence retrieved from the local storage comprises an electronic set of terms and conditions of a merchant associated with the disputed payment vehicle transaction.

16. The one or more machine-readable storage media of claim 11, wherein the plurality of instructions further cause the chargeback processing server to queue, in response to the determination that further review of the chargeback data is required, the chargeback message that corresponds to the disputed payment vehicle transaction in a queue for further review.

17. The one or more machine-readable storage media of claim 11, wherein the historical chargeback win data comprises a historical win rate and the transaction-specific economic feasibility data comprises a chargeback cost;
wherein to analyze the chargeback data as a function of the historical chargeback win data and transaction-specific economic feasibility data comprises to (i) determine whether a biased transaction amount is greater than a first reference threshold amount and (ii) determine whether the biased transaction amount is less than a second reference threshold amount, wherein the biased transaction amount comprises a product of the historical win rate and an adjusted gross transaction amount, the adjusted gross transaction amount comprises a difference between the transaction amount and the chargeback cost, and the first reference threshold amount is greater than the second reference threshold amount;
wherein to determine whether further review of the chargeback data is required comprises to determine that further review of the chargeback data is required in response to a determination that the biased transaction amount is between the first and second reference threshold amounts; and
wherein to determine whether to automatically represent the disputed payment vehicle transaction or automatically accept financial liability for the disputed payment vehicle transaction comprises to (i) determine to automatically represent the disputed payment vehicle transaction in response to a determination that the biased transaction amount is greater than the first reference threshold amount and (ii) determine to automatically accept financial liability for the disputed payment vehicle transaction in response to a determination that the biased transaction amount is less than the second reference threshold amount.

18. The one or more machine-readable storage media of claim 17, wherein the account identifier comprises a bank identification number;
wherein the chargeback cost comprises a chargeback fee associated with the disputed payment vehicle transaction and an estimated analyst time cost associated with the disputed payment vehicle transaction based on the chargeback reason code and the bank identification number; and
wherein the historical win rate comprises one or more of a global historical win rate and a merchant-specific historical win rate based on the chargeback reason code and the bank identification number.

19. A system for automatic chargeback management, the system comprising:
a chargeback processing server comprising a processor executing instructions stored in memory, wherein the instructions cause the processor to:
receive a chargeback message that corresponds to a disputed payment vehicle transaction, the chargeback message comprises chargeback data indicative of a transaction amount, an account identifier, and a chargeback reason code;
analyze the chargeback data as a function of historical chargeback win data and transaction-specific economic feasibility data;
determine whether further review of the chargeback data is required based on the analysis of the chargeback data;
determine, in response to a determination that further review of the chargeback data is not required, whether to automatically represent the disputed payment vehicle transaction or automatically accept financial liability for the disputed payment vehicle transaction based on the analysis of the chargeback data;
transmit a representment message in response to a determination to automatically represent the disputed payment vehicle transaction; and
transmit a liability acceptance message in response to a determination to automatically accept financial liability for the disputed payment vehicle transaction.

20. The system of claim 19, wherein the instructions of the chargeback processing server further cause the processor to:
collect representment evidence in response to the determination to automatically represent the disputed payment vehicle transaction; and
augment the representment message with the collected representment evidence.

21. The system of claim 20 wherein the instructions of the chargeback processing server further cause the processor to:
determine whether the disputed payment vehicle transaction is a physical goods shipping transaction;
request, from a remote evidence repository, proof of delivery evidence in response to a determination that the disputed payment vehicle transaction is a physical goods shipping transaction; and
receive, from the remote evidence repository, the proof of delivery evidence, wherein the collected representment evidence comprises the received proof of delivery evidence.

22. The system of claim 21, wherein to collect the representment evidence comprises to retrieve the representment evidence from a local storage in response to a determination that the disputed payment vehicle transaction is a transaction other than a physical goods shipping transaction.

23. The system of claim 19, wherein the instructions of the chargeback processing server further cause the processor to queue, in response to the determination that further review of the chargeback data is required, the chargeback message that corresponds to the disputed payment vehicle transaction in a queue for further review.

24. The system of claim 19, wherein the historical chargeback win data comprises a historical win rate and the transaction-specific economic feasibility data comprises a chargeback cost;
wherein to analyze the chargeback data as a function of the historical chargeback win data and transaction-specific economic feasibility data comprises to (i) determine whether a biased transaction amount is greater than a first reference threshold amount and (ii) determine whether the biased transaction amount is less than a second reference threshold amount, wherein the biased transaction amount comprises a product of the historical win rate and an adjusted gross transaction amount, the adjusted gross transaction amount comprises a difference between the transaction amount and the chargeback cost, and the first reference threshold amount is greater than the second reference threshold amount;
wherein to determine whether further review of the chargeback data is required comprises to determine that further review of the chargeback data is required in response to a determination that the biased transaction amount is between the first and second reference threshold amounts; and
wherein to determine whether to automatically represent the disputed payment vehicle transaction or automatically accept financial liability for the disputed payment vehicle transaction comprises to (i) determine to automatically represent the disputed payment vehicle transaction in response to a determination that the biased transaction amount is greater than the first reference threshold amount and (ii) determine to automatically accept financial liability for the disputed payment vehicle transaction in response to a determination that the biased transaction amount is less than the second reference threshold amount.

25. The system of claim 24, wherein the chargeback cost comprises a chargeback fee associated with the disputed payment vehicle transaction and an estimated analyst time cost associated with the disputed payment vehicle transaction based on the chargeback reason code; and
wherein the historical win rate comprises one or more of a global historical win rate and a merchant-specific historical win rate based on the chargeback reason code.
